(19) United States
(12) Patent Application Publication
(10) Pub. No.: US 2018/0194380 A1
(43) Pub. Date: Jul. 12, 2018

(54) METHOD AND SYSTEM OF RAILWAY TRACK PARAMETER MEASUREMENT AND CALCULATION

(71) Applicant: Saleh Akbari, Tehran (IR)

(72) Inventor: Saleh Akbari, Tehran (IR)

(21) Appl. No.: 15/866,441

(22) Filed: Jan. 9, 2018

(51) Int. Cl. B61L 25/08; B61L 1/18; B61L 23/04; G01S 19/50

(52) U.S. Cl. CPC B61L 25/08; B61L 1/181; H04W 4/023; G01S 19/50; B61L 23/042

(57) ABSTRACT

An improved method and system of measuring multiple railway track parameters via a survey device that can be installed on any vehicle traveling on a railway track is disclosed. The survey includes a sensor unit and a position determination unit that obtain various railway track parameters and their corresponding position coordinates and record the data at a storage medium. The data can then be transferred or communicated to a computing device configured to process the data and to quickly and efficiently obtain one or more of a railway track profile, plan, vibration chart, and rail discontinuity indices.

### TECHNICAL FIELD

The present application relates generally to railway track measurement and surveying and, more particularly, to an improved method and system of determining railway track parameters in conjunction with position recording to provide detailed charts of railroad track elevations, vibration and steepness, among other things.

### BACKGROUND

Conventional railroads are generally formed on a base layer of compacted material upon which a bed of gravel ballast rests. Crossties are positioned upon and in the ballast, and two parallel steel rails are secured to the ties with fasteners. The ballast stabilizes the positions of the crossties, keeps the rails level, and provides some cushioning for the loads imposed by rail traffic. The crossties distribute the loads from the cars to the ballast layer below the crossties and contribute to the cushioning effect of the railroad track structure. The crossties also maintain the gage or lateral spacing of the rails. Over time, the movement of tracked vehicles over the rails and various other factors cause the rails and the crossties to deteriorate, dislodge or break and/or displace some of the ballast.

The gage and other characteristics of railway tracks can be considered railway track parameters. When crossties and rails deteriorate or break, one or more railway track parameters change. In most railway systems, at least some railway track parameters must fall within specified ranges for safety requirements. If the railway track parameters fall outside those ranges, there could be a significant risk of railcar derailment, or at the very least inefficient rail travel.

As a result, several different solutions have been developed to conduct measurements to ensure railway track parameters fall within acceptable ranges. One such solution is manual inspection. However, the long distances of most railways render this solution labor intensive and as such impracticable. Other railway parameter and crosstie inspection systems and methods have a number of limitations in their use and present a variety of concerns.

Therefore, a need exists for providing an improved efficient, inexpensive and automated solution to the problem of railway parameter inspection and measurement.

### SUMMARY

A device for measuring railway track parameters is provided. In one implementation, the device for measuring railway track parameters includes a sensor unit including at least one of an accelerometer and a gyroscope, the sensor unit configured to provide a plurality of sensor signals obtained from a railway track the device travels on, a position determination unit for determining one or more position coordinates for the device at a given time, a communication unit, a processor configured to receive the plurality of sensor signals and the one or more position coordinates, and a memory readable by the processor unit. The memory includes instructions that cause the processor to process each of the plurality of sensor signals, determine a corresponding position coordinate for each of the plurality of sensor signals, and store each of the plurality of sensor signals along with its corresponding position coordinate in a database in the memory. The communication unit is configured to communicate the database to a computing device for utilizing the database in determining at least one of a railway track plan, profile, rail discontinuity indices and vibration profile for the railway track.

A method for calculating and displaying railway track parameters is also provided. In one implementation, the method for calculating and displaying railway track parameters includes receiving sensor signal data obtained by a railway track measuring device while traveling on a railway track, receiving one or more position coordinates associated with each of the sensor signal data, calculating a railway track plan based at least in part on the received sensor signal data and the received one or more position coordinates, calculating a railway track profile based at least in part on the received sensor signal data and the received one or more position coordinates, calculating a railway track vibration profile based at least in part on the received sensor signal data and the received one or more position coordinates, calculating a railway track discontinuity index based at least in part on the received sensor signal data, the received one or more position coordinates, and a predefined threshold for a power spectral density (PSD) of magnitude of vibration, and displaying at least one of the railway track plan, railway track profile, railway track vibration profile and the railway track discontinuity index on one or more charts.

### BRIEF DESCRIPTION OF THE DRAWINGS

Features of the subject technology are set forth in the appended claims. However, for purpose of explanation, several implementations of the subject technology are set forth in the following figures.

FIG. 1 is a block diagram of a system configured to provide improved measurement and calculation of one or more railway track parameters, in accordance with one or more aspects of the present application.

FIG. 2 is a schematic of a view of the system configured to provide improved measurement and calculation of one or more railway track parameters, in accordance with one or more aspects of the present application.

FIG. 3 is a flow chart for an improved process that provides one or more of a plan, profile, rail discontinuity index and vibration profile for a railway track, in accordance with one or more aspects of the present application.

FIG. 4 is an example schematic of a plan for a portion of a railway track provided by the process of FIG. 3, in accordance with one or more aspects of the present application.

FIG. 5 is an example schematic of a profile for a portion of a railway track provided by the process of FIG. 3, in accordance with one or more aspects of the present application.

FIGS. 6A-6B are example charts provided by the process of FIG. 3 for determining a vibration profile of a railway track, in accordance with one or more aspects of the present application.

FIGS. 7A-7B are example charts provided by the process of FIG. 3 for determining rail discontinuities in a railway track, in accordance with one or more aspects of the present application.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. As part of the description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

The gage, elevation, curvature, wrap and runoff and other characteristics of railway tracks can be considered railway track parameters. When crossties and rails deteriorate or break, railway track parameters may change. In most railway systems, railway track parameters must fall within specified ranges for safety requirements. Moreover, deteriorations in rails can sometimes result in rail surface and/or side discontinuities. As a result, it is important to conduct periodic surveys of railway tracks to ensure safety and/or ascertain the quality of the ride to be expected on vehicles traveling on the railway tracks.

In the past, different types of methods and systems have been proposed for use in determining the profile, alignment, elevation, track gage, curvature, and other parameters of a railway track. One method of track inspection is performed by track inspectors walking along the track or riding at slow speed in a high-rail vehicle. However, such discontinuity inspections only provide a limited amount of data and have proven to be slow and inefficient for inspection of long distance railway tracks which must be maintained to meet safety and comfort standards.

Some devices have been developed that are capable of measuring certain railway track parameters while traveling on a railway track at specific speeds. However, these devices either have to travel at low speeds, lack the desired level of accuracy or only measure a limited number of parameters.

A solution is proposed here to solve these issues and more by providing an improved method and system of measuring multiple railway track parameters via a small measurement device that can be installed on any vehicle traveling on a railway track. In one embodiment, the device includes a sensor unit and a position determination unit that obtain various railway track parameters and their corresponding positions, and records the data at a storage medium. The data can then be transferred or communicated to a computing device configured to process the data and to quickly and efficiently obtain one or more of the railway track profile, plan, vibration profile, and rail discontinuity indices.

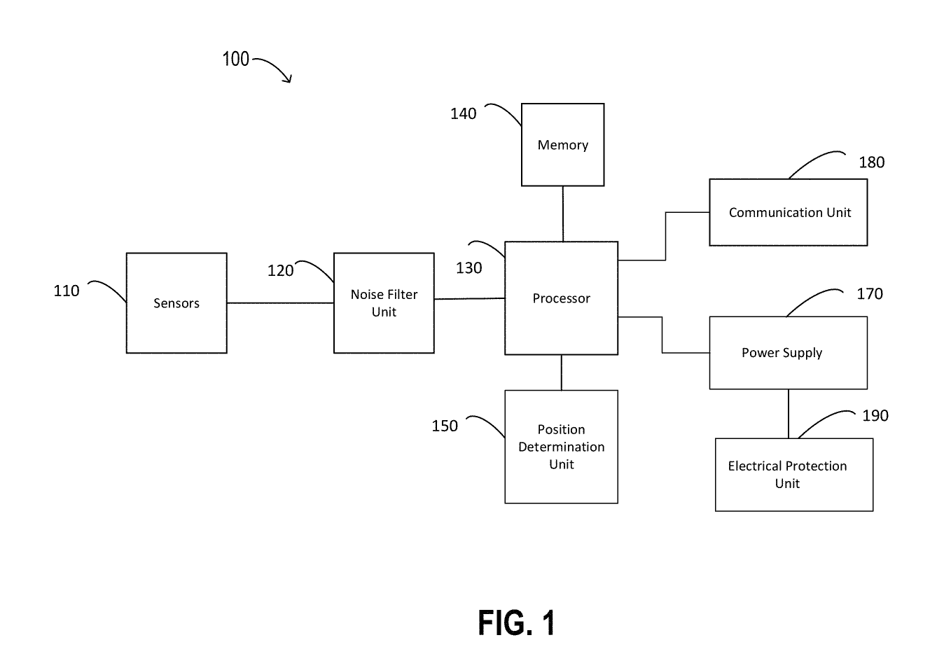

FIG. 1 illustrates an exemplary block diagram for a system 100 providing improved measurement and calculation of one or more railway track parameters. The system 100 includes a sensor unit 110 which includes one or more sensors. In one implementation, the sensors in the sensor unit 110 include one or more accelerometers and gyroscopes for capturing orientation, position, acceleration, and the like and one or more temperature sensors for measuring the temperature of the environment. The measured temperature is used, in one implementation, for an error compensation mechanism used in the sensor unit 110. In one implementation, other non-contact sensors such as photo-optical sensors and laser beams may be included to obtain additional parameters and/or increase the accuracy of the parameters obtained. It should be noted that, even though, the sensor unit 110 is shown as one entity, one or more sensors of the sensor unit 110 may be located at different places within the system 100 in a predetermined layout to increase their capabilities at capturing the appropriate signals.

After being captured, signals from the one or more sensors within the sensor unit 110 are transmitted, in one implementation, to a noise filtering unit 120 to reduce the amount of noise present in the signals. The noise filtering unit 120 may include one or more low pass filters for smoothing the sensor signals. Other noise reducing filters, known in the art, may also be used in other implementations.

The system 100 also includes a processor 130 which may include one or more processors for executing computer readable instructions stored in a memory 140 in order to perform one or more of the processes discussed herein. Additionally, the processor 130 may include one or more hardware or firmware logic units configured to execute hardware or firmware instructions. In one implementation, the processor 130 is a microcontroller processor unit. The processor 130 may be single core or multicore, and the programs executed thereon may be configured for parallel or distributed processing.

In one implementation, the processor 130 receives inputs from the noise filtering unit 120 and a position determination unit 150 to process and analyze the reduced noise signals, calculate the precise location of each sensor signal based on the data received from the position determination unit 150, and establish a relationship between the sensor signals, and their corresponding positional coordinates. In this manner, each sensor signal is associated with one or more positional coordinates to determine the location of the sensor measurements with high accuracy. This data is stored in a database in the memory 140 for future use. In one implementation, the data is stored in an Excel file for ease of transfer and use. In one implementation, the processor 130 executes a report generator program stored in the memory 140 to process and store the data.

The memory 140 may include removable media and/or built-in devices. For example, memory 330 may include flash memory devices (e.g., SD, Micro SD, Flash Drive, etc.) optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Memory 130 may also include devices with one or more of the following characteristics: volatile, nonvolatile, dynamic, static, read/write, read-only, random access, sequential access, location addressable, file addressable, and content addressable. In one implementation, the memory 140 includes a SD card or a flash drive that can be easily removed and inserted into a different computing device such that the stored data can be quickly transferred to other devices. In one implementation, a SD card having an 8 GB capacity can store the processed data for up to 14 days of railway track surveys. SD cards have increased capacities of up to 128 GB may be used to increase the storage capacity of the system 100.

The position determination unit 150 may include one or more positioning systems such as the Global Positioning System (GPS), GLONASS, and Galileo, among others. In one implementation, the position determination unit 150 includes a Differential Global Positioning System (DGPS) which is capable of improving location accuracy from about 15 meters for a GPS system to about 30 cm. By using a DGPS with such a high degree of location accuracy, the system 100 can provide highly accurate railway track parameter and rail discontinuity information.

The system 100 also includes a power supply unit 170 for providing power to the various components of the system 100. In one implementation, the power supply unit 170 includes AC adopter inputs for directly connecting the system to an AC power supply unit and one or more batteries for providing power to the system 100 while direction connection is not available. The batteries may be rechargeable or non-rechargeable. In one implementation, rechargeable batteries are used that are charged when the system 100 is connected to an AC power input. The charged batteries may supply power to the system 100 for up to three days without a need for being recharged.

In one implementation, the system 100 also includes a communication unit 180 for direct connection to one or more computing devices. The communication unit 180 may be a USB port that provides simple access to the information stored on the memory 140 on any computing device having USB capabilities. The USB port may also be used to program or modify the programming of the system 100. Alternatively, the system 100 may include one or more additional ports (not shown) designated for programming the device. The communication unit 180 may also include wireless communication capabilities. For example, the communication unit 180 may include Bluetooth or other short-range communication capabilities. Alternatively, the communication unit 180 may provide cellular and/or WiFi communication.

The system 100 may also include an electrical protection unit 190 for protecting various components of the system 100 from power system faults. Electrical protection units are well known in the art and will not be discussed here in detail.

It should be noted that FIG. 1 has been simplified for clarity and does not depict all components of the system 100, as the system 100 may include various other commonly used components that are well known in the art.

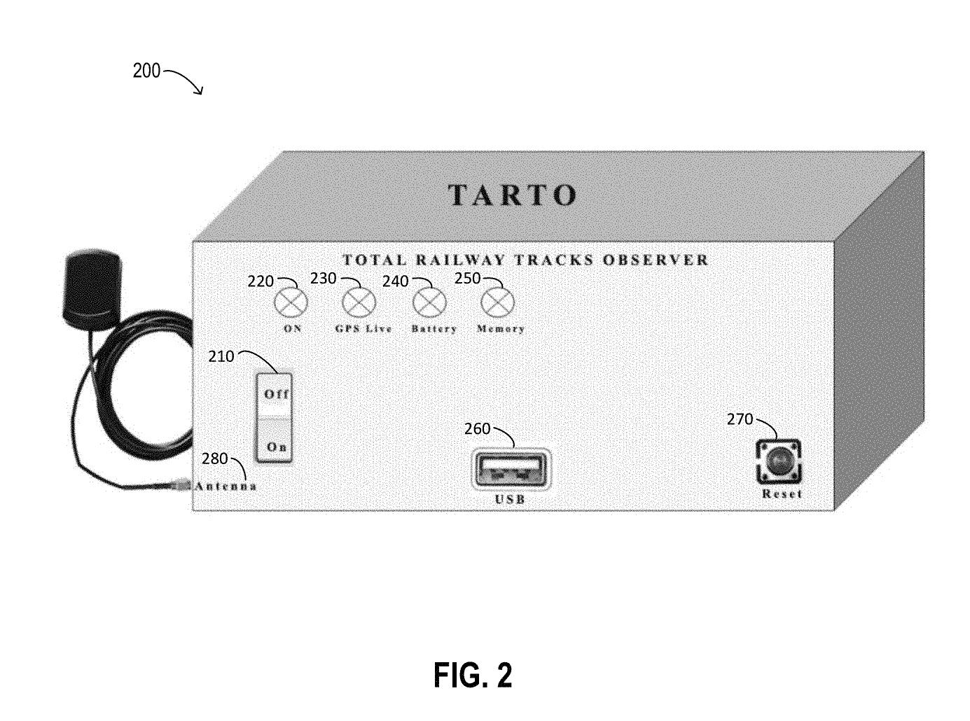

FIG. 2 depicts a view 200 from the outside of the system 100 of FIG. 1, which may be referred to, in one implementation, as the total railway tracks observer. As shown in FIG. 2, in addition to the elements shown in FIG. 1, system 100 also includes a power switch 210 for turning the device on and off. It should be noted that although, depicted as a switch, the power switch 210 may be any kind of button usable for powering an electronic device on and off. The system 100 also includes multiple indicative lights for signaling status of various components of the system 100. In one implementation, these indicative lights include an on/off light 220 which comes on when the device is turned on to show that it is on and operating, and a GPS live light to show that the position determination unit 150 is turned on. The indicative lights also include a battery light 240 and a memory light 250 which may turn on when the system 100 is low on battery or memory, respectively. In an alternative implementation, the battery light 240 and memory light 250 may be on while the device is on, but may turn a different color or start blinking when the battery or memory levels fall below certain predetermined thresholds.

In one implementation, the system 100 also includes a reset button 270 for resetting the device. The reset button 270 may cause the data stored in the memory to be deleted, thereby making additional storage space available for additional data. The reset button 270 may also reset certain settings of the device and/or revert one or more modified programs on the device to their original settings. The system 100 may also include a USB port 260 which may be a part of the communication unit 180 and can be utilized to connect the system 100 to any USB compatible computing device, thereby enabling easy transfer of the data stored on the system 100. Furthermore, the system 100 includes an antenna 280 that strengths the capabilities of the position determination unit 150 to ensure that even in inclement weather conditions, the system continues accurately obtaining position coordinates. The wire shown in FIG. 2 is part of the antenna 280 and is helpful in strengthening the capabilities of the position determination unit 150.

In one implementation, the system 100 is a universal unit that can be used with and positioned on all known types of railcars, locomotives, and other railway rolling stocks that travel on a railway track at any reasonable speed. This is advantageous, as most prior railway survey systems had to be installed on particular types of vehicles traveling at specific speeds. Moreover, the system 100 is portable and because of its small size can easily be installed at any location on the vehicle traveling on the railroad track. In a preferred embodiment, however, the system 100 is positioned on the journal box of a train traveling on the railroad track for obtaining more accurate sensor signals. In one implementation, the system 100 can be installed on any railcar in less than 10 minutes. As the train moves along the railroad tracks, the system 100 can continuously measure and record railroad track parameters until it is turned off or runs out of battery or memory space.

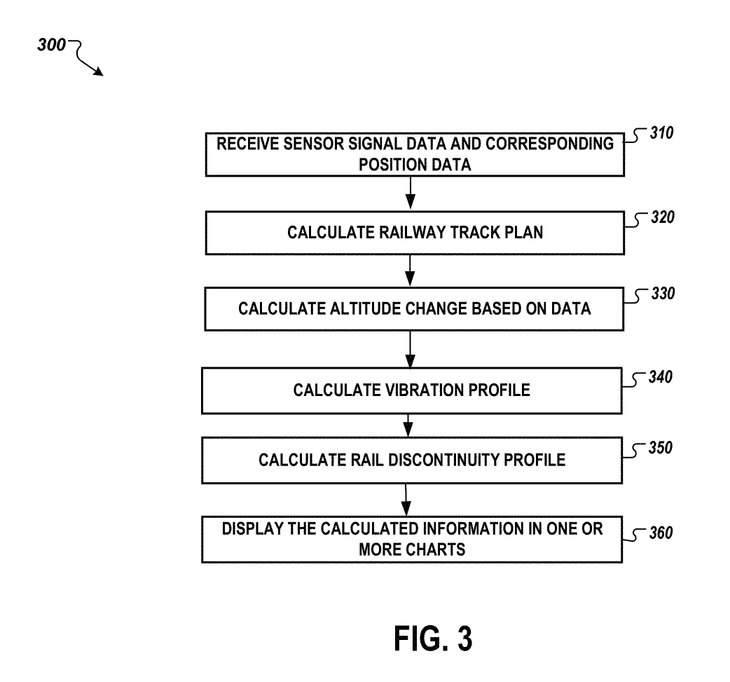

FIG. 3 is a flow diagram depicting an example method 300 for calculating and providing various railway track parameters and charts, which may be performed by a computing device. The computing device may be any device capable of receiving and processing a large amount of data and includes, in one implementation, the processor 130 of the system 100 of FIG. 1.

At 310, the method 300 includes receiving sensor signal data from the railway track along with the corresponding position coordinates for each of the sensor signals. In one implementation, this information is received from the system 100 of FIGS. 1 and 2 either directly or indirectly. For example, the data may be received directly from the system 100 when the communication unit 180 of the system 100 is utilized to directly connect the system 100 to a computing device. Alternatively, the data may be transferred indirectly when a removable memory of the system 100 is removed and connected to a computing device. Another alternative may involve receiving the data from an intermediary device to which the database was transferred.

Once received, the sensor signal data can be used to calculate various railway track parameters. For example, accelerometer signal data along with the corresponding position coordinate information is used, at 320, to calculate the exact route of the railway track. This is done, in one implementation, by putting together the location coordinates at which each sensor signal was recorded consecutively to determine the route. The resulting route is sometimes referred to as a railway track plan. At 330, the received data is used to calculate the slope, roll and yaw changes in the railway track route travelled by the system. This is done, in one implementation, in each of the three XYZ dimensions. Variations in slope in the X dimension (i.e., changes in degree of the X vector of movement) can be displayed in a chart referred to as the profile and can be used to examine compliance with safety requirements by ensuring that the slope of the railway tracks at any given portion of the track falls within required ranges.

At 340, the method 300 uses the sensor signal data and their corresponding position coordinates to calculate the amount of vibration applied to the vehicle at any point on the railway track, in any of the X, Y, and Z dimensions. The mount of vibration is calculated, in one implementation, by calculating a difference between consecutive sensor signal data and can be used to infer the condition of the railway track. For example, an amount of vibration that falls outside an acceptable range may indicate damage to the rails or crossties or rail discontinuities under certain conditions. This and other information from the sensor signal data is used, at 350 to calculate a rail discontinuity profile. In one implementation, the discontinuity profile is generated by identifying points in the vibration profile at which the power spectral density (PSD) of magnitude of vibration passes a predefined threshold. The rail discontinuity profile may indicate locations along the railway track where rail discontinuities exist or are developing. This information can be very helpful in preventing derailment and thereby possible accidents. At 360, all of the calculated information can be displayed on one or more charts designed to convey the necessary information to a user. These charts include, in one implementation, a railway track plan, profile, vibration profile and a rail discontinuity profile.

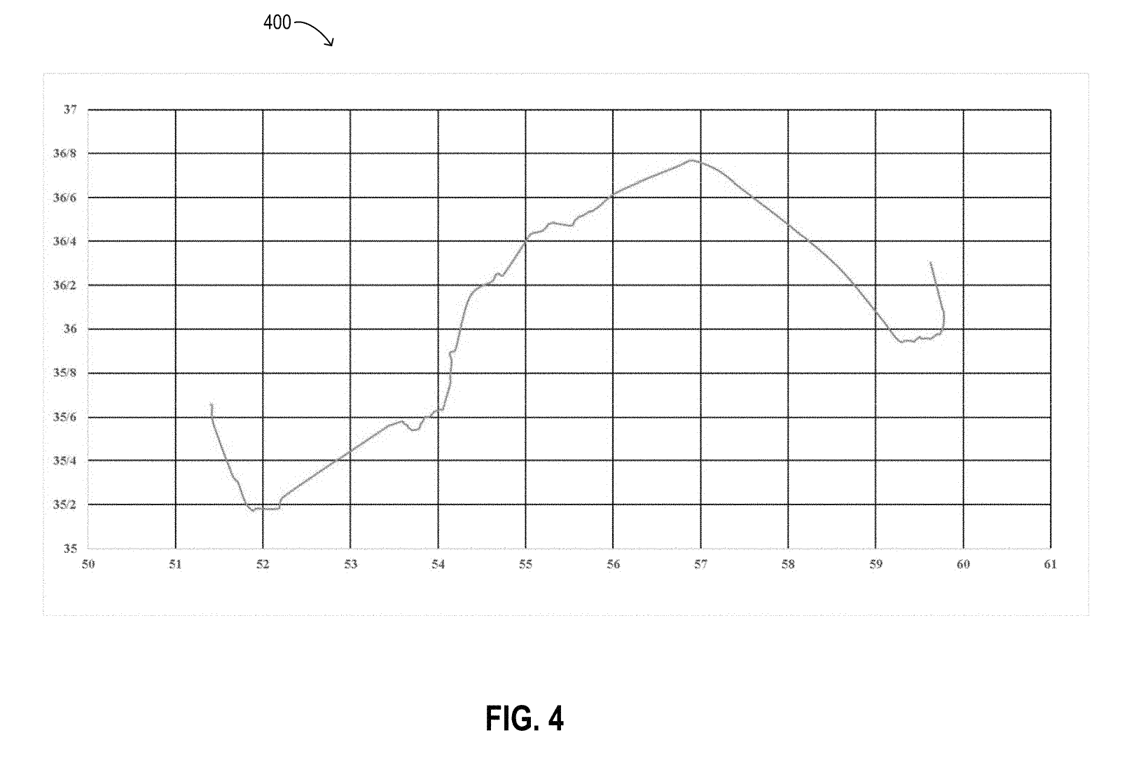

FIG. 4 depicts an example railway track plan 400 for a route traveled by a vehicle equipped with the improved measurement and survey device disclosed herein. The X axis in the plan 400 shows the longitude and the Y axis shows the latitude coordination of the travelled railway track. The plan 400 show details such as curvature along the route and as such can be useful in ensuring railway track parameters relating to the shape of the route fall within acceptable safety standards.

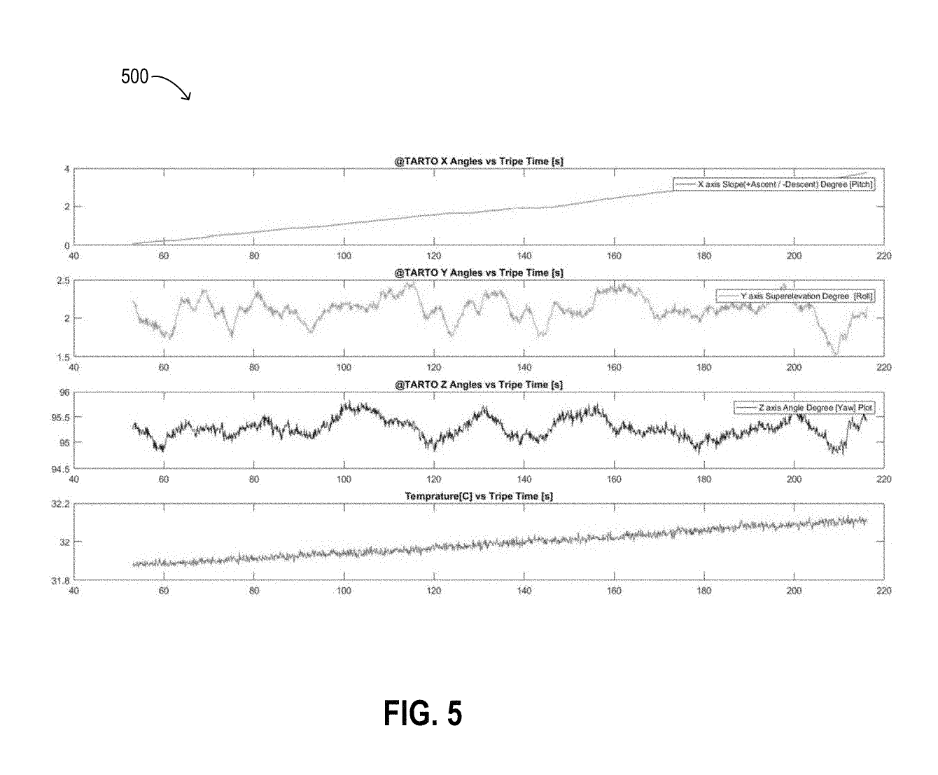

FIG. 5 depicts an example railway track profile 500. In one implementation, the profile 500 includes the three XYZ dimensions, in addition to a temperature chart. In each of the three X, Y, and Z charts, the vertical axis shows the degree and the horizontal axis shows the corresponding trip time.

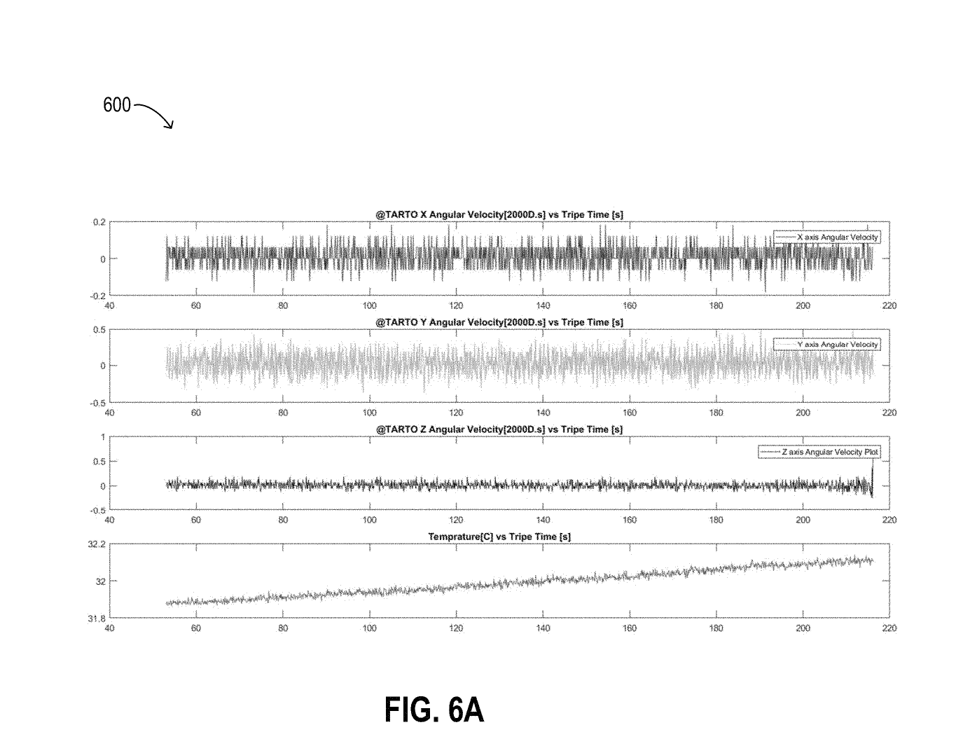

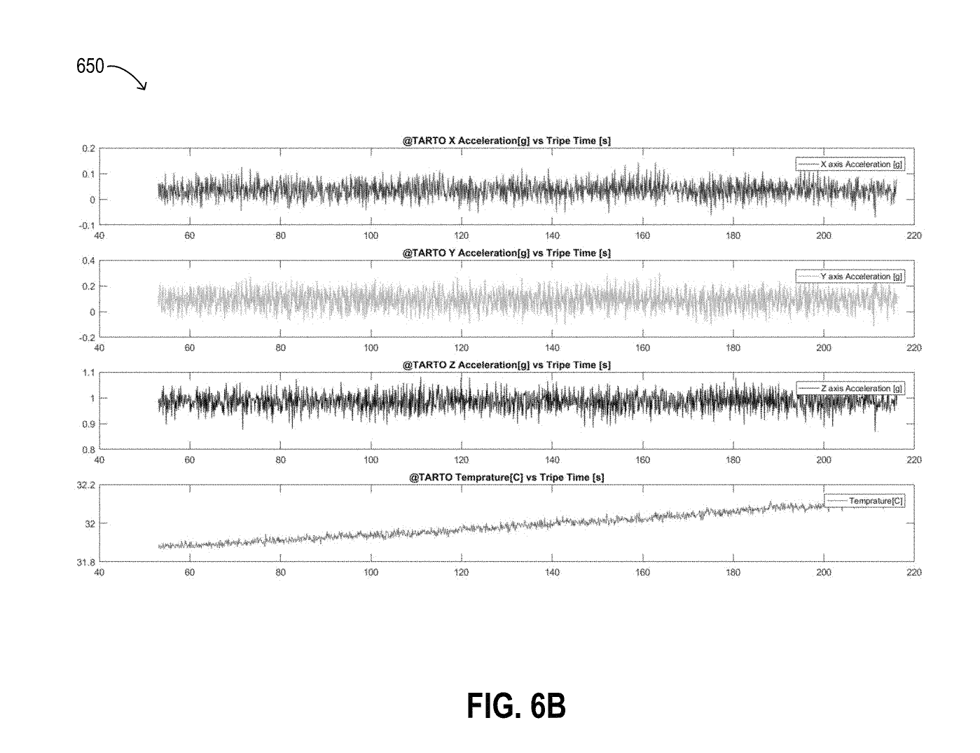

FIGS. 6A-6B depict two types of charts that can be used for determining the vibration profile of a railway track. Chart 600 of FIG. 6A depicts a vibration profile calculated based on a time-domain angular velocity pattern. Chart 650 of FIG. 6B, in turn, shows a vibration profile that illustrates gravity acceleration changes with time. These charts demonstrate the amount of vibration applied to the vehicle traveling on the railway track and can be used to infer railway track conditions.

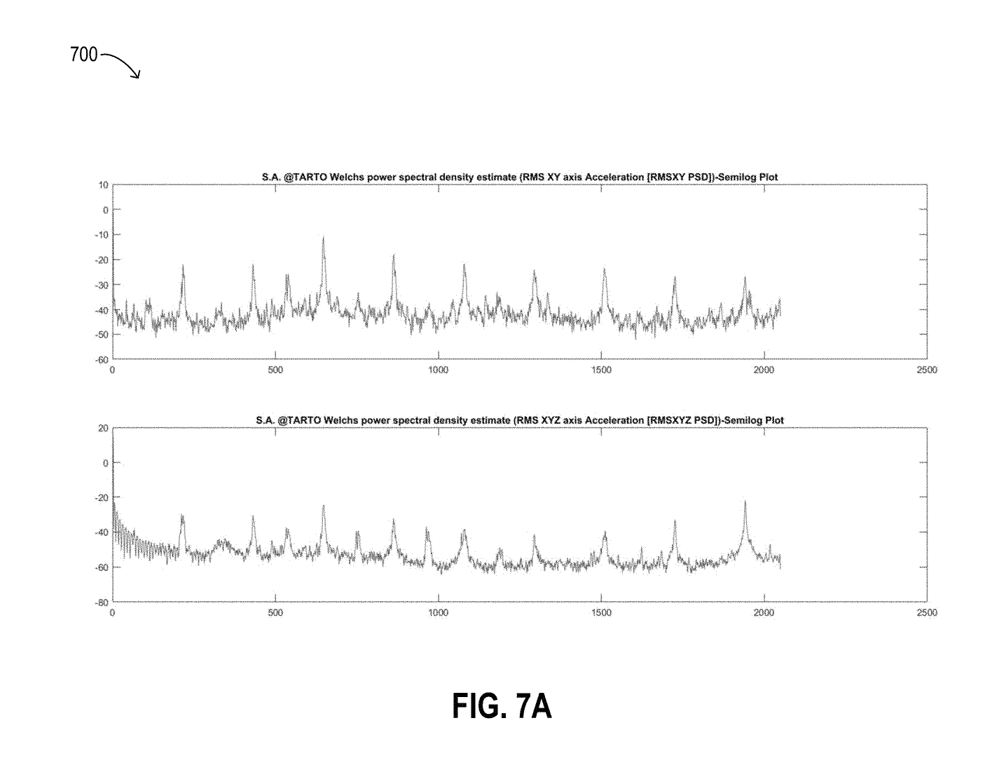

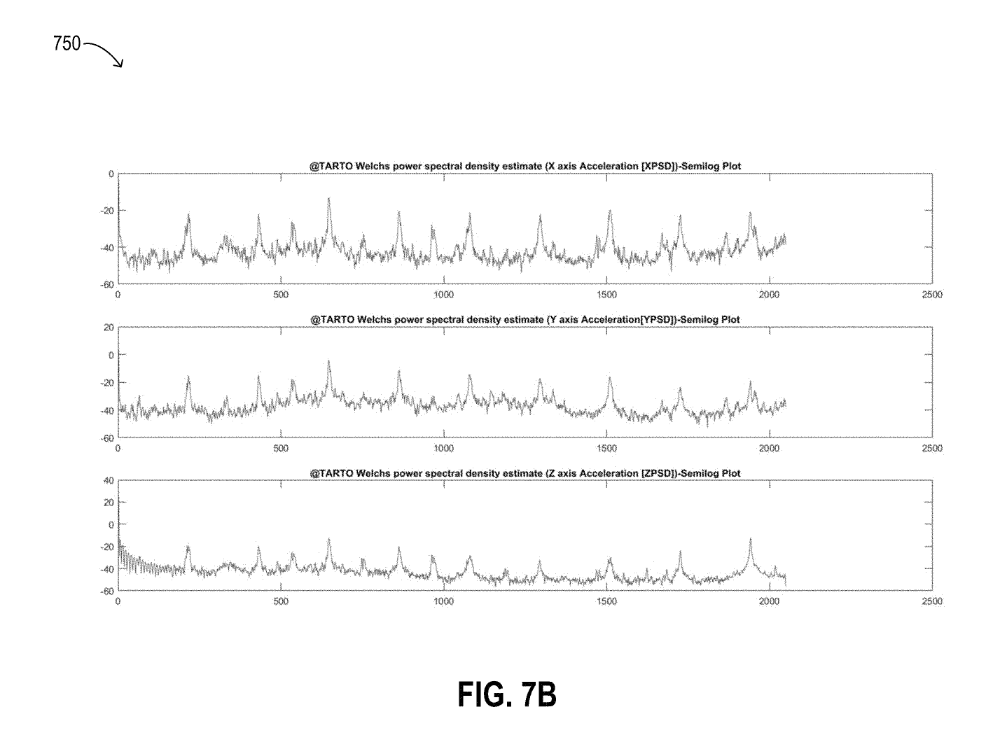

FIGS. 7A-7B depict rail discontinuity indices at a given location. In charts 700, the Y axis is dB and the X axis shows a selectable location of the railway track route. Alternatively, the X axis can show the time for each point in the Y axis. The upper chart in the charts 700 depicts the rail discontinuity indices calculated based on the X and Y vector measurements and the lower chart depicts the rail discontinuity indices calculated based on the X, Y, and Z vector measurements. Charts 750 depict rail discontinuity indices at a given location and are shown for each of the X, Y, and Z axis. As discussed above, this information can be very useful in identifying rail discontinuities accurately and thereby preventing dangerous accidents.

Accordingly, the improved measurement and survey device is a portable plug and play and self-powered unit which can be used to capture and store sensor signal indicative of railway track parameters and their corresponding position coordinates to a high degree of accuracy with a small portable and easily installable device. Data stored on the measurement device can then be transferred to another computing device to calculate various railway track parameters and display those parameters in charts such as railway track plan, profile, vibration profile and rail discontinuity indices.

The separation of various components in the examples described above should not be understood as requiring such separation in all examples, and it should be understood that the described components and systems can generally be integrated together in a single packaged into multiple systems.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A device for measuring railway track parameters comprising:
a sensor unit including at least one of an accelerometer and a gyroscope, the sensor unit configured to provide a plurality of sensor signals obtained from a railway track the device travels on;
a position determination unit for determining one or more position coordinates for the device at a given time;
a communication unit;
a processor configured to receive the plurality of sensor signals and the one or more position coordinates; and
a memory readable by the processor unit and comprising instructions stored thereon to cause the processor to:
process each of the plurality of sensor signals;
determine a corresponding position coordinate for each of the plurality of sensor signals; and
store each of the plurality of sensor signals along with its corresponding position coordinate in a database in the memory;
wherein the communication unit is configured to communicate the database to a computing device for utilizing the database in determining at least one of a railway track plan, profile, rail discontinuity indices and vibration profile for the railway track.

2. The device for measuring railway track parameters of claim 1, further comprising at least one noise filter unit for reducing noise in the plurality of sensor signals.

3. The device for measuring railway track parameters of claim 1, further comprising a power supply.

4. The device for measuring railway track parameters of claim 3, wherein the power supply includes an AC adapter port and at least one battery.

5. The device for measuring railway track parameters of claim 4, wherein the battery is a rechargeable battery that can be charged when the AC adapter port is connected to power.

6. The device for measuring railway track parameters of claim 1, wherein the memory includes a removable secure digital (SD) card.

7. The device for measuring railway track parameters of claim 1, wherein the database includes an Excel file.

8. The device for measuring railway track parameters of claim 7, further comprising an electrical protection unit.

9. The device for measuring railway track parameters of claim 1, wherein the position determination unit includes a Differential Global Positioning System (DGPS) for providing highly accurate position coordinates.

10. The device for measuring railway track parameters of claim 1, further comprising at least one indicative light for depicting the status of one or more components of the device.

11. The device for measuring railway track parameters of claim 10, wherein the at least one indicative light includes a light showing if the device is on, a Global Positioning System (GPS) light showing that the position determination unit is turned on, a battery light indicating the charge level of a battery and a memory light indicating a storage capacity of the memory.

12. The device for measuring railway track parameters of claim 1, wherein the communication unit includes a USB port.

13. The device for measuring railway track parameters of claim 1, wherein the railway track plan depicts a route for at least a portion of the railway track traveled by the device.

14. The device for measuring railway track parameters of claim 1, wherein the vibration profile depicts an amount of vibration applied to the device while traveling on the railway track.

15. A method for calculating and displaying railway track parameters comprising:
receiving sensor signal data obtained by a railway track measuring device while traveling on a railway track;
receiving one or more position coordinates associated with each of the sensor signal data;
calculating a railway track plan based at least in part on the received sensor signal data and the received one or more position coordinates;
calculating a railway track profile based at least in part on the received sensor signal data and the received one or more position coordinates;
calculating a railway track vibration profile based at least in part on the received sensor signal data and the received one or more position coordinates;
calculating a railway track discontinuity index based at least in part on the received sensor signal data, the received one or more position coordinates, and a predefined threshold for a power spectral density (PSD) of magnitude of vibration; and
displaying at least one of the railway track plan, railway track profile, railway track vibration profile and the railway track discontinuity index on one or more charts.

16. The method for calculating and display railway track parameters of claim 15, wherein the one or more chart displaying the railway track plan depicts a route for at least a portion of the railway track.

17. The method for calculating and display railway track parameters of claim 15, wherein the one or more chart displaying the railway track profile depicts slope changes for at least a portion of the railway track.

18. The method for calculating and display railway track parameters of claim 15, wherein the one or more chart displaying the railway track vibration profile depicts an amount of vibration applied to the device while traveling on the railway track.

19. The method for calculating and display railway track parameters of claim 15, wherein the one or more chart displaying the railway track discontinuity index depicts rail discontinuity indices for each given location of the railway track.

20. The method for calculating and display railway track parameters of claim 15, wherein the one or more chart displaying the railway track discontinuity index depicts rail discontinuity indices a given time while the measuring device travels on the railway track.
